(19) United States
(12) Patent Application Publication
(10) Pub. No.: US 2009/0141172 A1
(43) Pub. Date: Jun. 4, 2009

(54) TV System, Multimedia Processing Apparatus, and Method Thereof

(75) Inventor: Chuan-Te Liu, Keelung City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK, INC., Hsinchu (TW)

(21) Appl. No.: 11/947,969

(22) Filed: Nov. 30, 2007

(51) Int. Cl. H04N 5/46

(52) U.S. Cl. 348/558; 348/E05.114

(57) ABSTRACT

A TV system, a multimedia processing apparatus, and a method thereof are provided. The TV system comprises a multimedia processing apparatus and a display unit. The multimedia processing apparatus comprises a multiplexer, a controller, and a detector. The multiplexer receives a plurality of input signals. The controller signals the multiplexer to select one of the plurality of input signals in turn. The detector detects the selected input signal to generate a status of the selected input signal until all of the input signals have been detected. Then, the display unit displays the detected input signals.

### CROSS-REFERENCES TO RELATED APPLICATIONS

Not applicable

### BACKGROUND OF THE INVENTION

1. Field of the Invention

The present invention relates to a TV system, a multimedia processing apparatus, and a method thereof; in particular, it relates to a TV system, a multimedia processing apparatus, and a method for representing statuses of input signals without having to switch and watch the input signal content.

2. Descriptions of the Related Art

Television systems that support several multimedia inputs have been emerging in the market. The multimedia inputs can come from analog or digital sources. Analog TV sources comprise a CVBS signal (“Color, Video, Blank and Sync”, “Composite Video Baseband Signal”, “Composite Video Burst Signal”, or “Composite Video with Burst and Sync”), an S-video (separate video) signal, a VGA (video graphics array) signal, and an YPbPr, etc. Digital TV sources comprise an HDMI (high definition multimedia interface) signal and the like. Such a television system allows a user to select one TV source from the inputs to watch.

However, due to changing environmental factors, such as climatic fluctuations, a conventional TV system might receive weak TV sources or even unable to receive some of the TV sources. In the prior art, the user cannot obtain the statuses of the inputs, such as the formats and availability, until the user switches channels to see if the TV sources are still available. Such an operation is inconvenient and time-consuming. Therefore, an efficient way that allows a user to obtain statuses of TV sources is needed in the industrial field.

### SUMMARY OF THE INVENTION

An object of this invention is to provide a multimedia processing apparatus. The multimedia processing apparatus comprises a multiplexer, a controller, and a detector. The multiplexer receives a plurality of input signals. The controller controls the multiplexer to select one of the plurality of input signals in turn. The detector detects the selected input signal to generate a status of the selected input signal until all of the input signals are detected.

Another object of this invention is to provide a multimedia processing method. The multimedia processing method comprises the following steps: receiving a plurality of input signals; selecting one of the plurality of input signals in turn; and detecting the selected input signal to generate a status of the selected input signal until all of the input signals are detected.

Another object of this invention is to provide a TV system. The TV system comprises a multiplexer, a controller, a detector, and a display unit. The multiplexer receives a plurality of input signals. The controller controls the multiplexer to select one of the plurality of input signals in turn. The detector detects the selected input signal to generate a status of the selected input signal until all of the input signals are detected. In the end, the display unit displays the detected input signals.

Another object of this invention is to provide a multimedia processing apparatus. The multimedia processing apparatus comprises: means for receiving a plurality of input signals; means for selecting one of the plurality of input signals in turn; and means for detecting the selected input signal to generate a status of the selected input signal until all of the input signals are detected.

With the present invention, the status of each input signal would be detected before a user actually chooses one to watch. These detected statuses are then shown so that the user knows which input signal is available without having to switch to watch the input signal content.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a first embodiment in accordance with the present invention;

FIG. 2 shows a display of the statuses input signals of the first embodiment;

FIG. 3 shows a second embodiment in accordance with the present invention;

FIG. 4 shows a user interface menu of the second embodiment; and

FIG. 5 shows a flow chart of a multimedia processing method in accordance with the present invention.

### DESCRIPTION OF THE PREFERRED EMBODIMENT

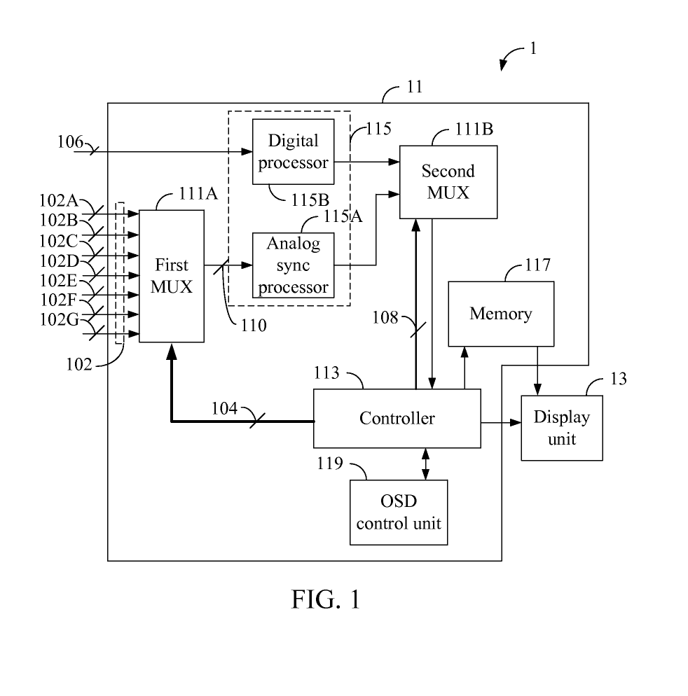

FIG. 1 shows a first embodiment of the present invention, which is a TV system 1 for broadcasting either a digital TV source or an analog TV source. The TV system 1 comprises a multimedia processing apparatus 11 and a display unit 13.

The multimedia processing apparatus 11 comprises a first multiplexer 111A, a second multiplexer 111B, a controller 113, a detector 115, a memory 117, and an OSD control unit 119. The first multiplexer 111A receives a plurality of analog input signals 102 and an n-bit control signal 104, wherein n is an integer. The plurality of analog input signals 102 comprises, at most, 2ⁿ signals. The n-bit control signal 104 is transmitted via a bus line from the controller 113. In this embodiment, the number n is 3, and the analog input signals 102 are a first CVBS signal 102A, a second CVBS signal 102B, a first S-video signal 102C, a VGA signal 102D, a TV signal 102E, a second S-video signal 102F, and a YPbPr signal 102G Though this embodiment uses one multiplexer, namely, the first multiplexer 111A, to select one of the analog input signals 102, the number of used multiplexer can be increased in response to practical needs. For example, one multiplexer may be employed for four analog input signals while another multiplexer can handle the remaining analog input signals. In addition to the analog input signals 102, the TV system 1 also receives a digital signal 106, i.e., a HDMI signal.

The controller 113 transmits the n-bit control signal 104 to the first multiplexer 111A so that the first multiplexer 111A can select one of the analog input signals 102. For example, the controller 113 may signal the first multiplexer 111A to select the analog input signals 102 in the following sequence: the first CVBS signal 102A, the second CVBS signal 102B, the first S-video signal 102C, the VGA signal 102D, the TV signal 102E, the second S-video signal 102F, and the YPbPr signal 102G It is noted that HDMI, CVBS, S-video, VGA, TV, and YPbPr are different kinds of sources of the input signals 102, 106. The controller 113 functions like a microcontroller, such as ones like the 8031, 8032, 8051 of INTEL MCS-51 series, ATMEL 89C51, etc. The detector 115 detects the selected analog input signal 110 and the digital signal 106 until all of the input signals 102, 106 are detected to generate a status for each of the input signals 102, 106. The status comprises the format and the availability of the corresponding input signal. In this embodiment, the detector 115 comprises two elements: one is an analog sync processor 115A and the other is a digital processor 115B for detecting the selected analog input signal 110 and the digital input signal 106, respectively. The analog sync processor 115A decodes the selected analog input signal 110 to obtain color difference information thereof in order to realize the format of the selected analog input signal 110, and also determine the availability of the selected analog input signal 110. The digital processor 115B receives and decodes the HDMI signal 106 to obtain color difference information thereof in order to realize the format of the HDMI signal 106, and also determine the availability of the HDMI signal 106. For example, the format of the HDMI signal 106 can be determined as 720P (720 progressive) or 1080I (1080 interlaced), while the format of the TV signal 102E can be determined as NTSC, PAL, or SECAM. The availability of these input signals 102, 106 are determined by counters (not shown) and comparators (not shown) of the analog sync processor 115A and the digital processor 115B, respectively. The counters count the numbers of toggle of the input signals 102, 106. Then the comparators compare the numbers of toggle with a threshold number. If the number is greater than the threshold number, for example, 15 toggles, then the counted input signal is determined available. Otherwise, the counted input signal would be determined unavailable when there are less than 15 toggles.

After detection, the statuses are transmitted to the second multiplexer 111B. The second multiplexer 111B receives a 1-bit control signal 108 from the controller 113 to select the detected results from the analog sync processor 115A and the digital processor 115B. In particular, the control signal 108 is configured to select the detected results of the analog input signals 102 or the digital input signal 106. If the control signal 108 first selects the detected results from the analog input signals 102, then the controller 113 would receive the detected results from the second multiplexer 111B in the following sequence: the first CVBS signal 102A, the second CVBS signal 102B, the first S-video signal 102C, the VGA signal 102D, the TV signal 102E, the second S-video signal 102F, the YPbPr signal 102G, and finally, the HDMI signal 106. If the control signal 108 first selects the detected results of the digital input signal 106, then the controller 113 receives the detected results in the following sequence: the HDMI signal 106, the first CVBS signal 102A, the second CVBS signal 102B, the first S-video signal 102C, the VGA signal 102D, the TV signal 102E, the second S-video signal 102F, and finally, the YPbPr signal 102G The controller 113 transmits the statuses of the input signals 102, 106 to the memory 117 for storage. When a user requests the statuses, these statuses are transmitted to the display unit 13 for display.

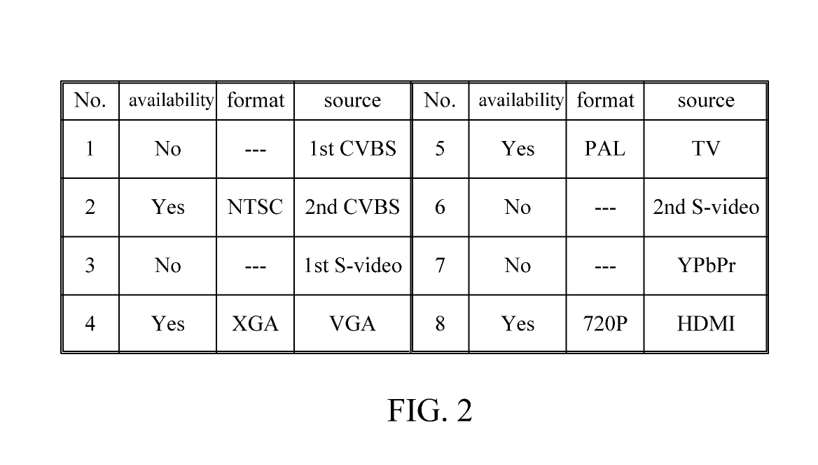

The statuses can be shown through an on-screen-display (OSD). When the user manually requests the statuses, a table, as shown in FIG. 2, is formed by the OSD control unit 119 and displayed by the display unit 13. The table lists the input terminals, the availabilities, the formats, and the sources of all the input signals 102, 106. In this embodiment, only the second CVBS signal 102B, the VGA signal 102D, the TV signal 102E, and the HDMI signal 106 are available. The order shown in the table is determined by a plurality of predetermined priorities. For example, the first CVBS signal 102A has the highest priority and the HDMI signal 106 has the lowest priority. In other embodiments, the statuses of the input signals 102, 106 are displayed in a certain order which can be determined via a manual input by the user. According to the table, the user may select one of the available input signals to watch without having to switch to watch. Moreover, the selection of available input signals for display can be a user selection, a jump selection executed according to a display priority, or the combination thereof. Give the combination as an example, when the user selects the TV signal 102E for watching from the table, the display unit 13 would display the display frame of this TV signal 102E of the corresponding channel. If the TV signal 102E is suddenly unavailable at the moment, the display unit 13 would jump to display the display frame of the next available input signal according to the display priority. In other embodiments, the first multiplexer 111A, the second multiplexer 111B, the controller 113, and the detector 115 are capable of operating periodically. As a result, the statuses of the input signals 102, 106 stored in the memory 117 can also be updated periodically. The period can be of any time interval, such as 0.1 seconds. Except for the table shown in FIG. 2, there are many other ways to show availabilities of input signals. For example, the available input signals can be marked with other colors or with an underline instead of being listed in the table. The display unit 13 would display “non-valid” to show that there's an error, such as noise or in informal format, in the input signal.

In other embodiments, costs may be saved if the detector 115 is a simple detector and/or a format detector rather than an analog sync processor 115A or a digital processor 115B. The simple detector is just configured to detect the availability of all the input signals 102, 106. The format detector further detects the formats of all input signals 102, 106. In such a case, the TV system 1 further comprises a decoder. After detecting by the simple detector and/or the format detector, the detected input signals are decoded by the decoder to obtain the statuses for display.

When the user requests the information of the input signals 102, 106, the display unit 13 may display the availability and the format of each available input signal simultaneously. As FIG. 1 shows, the controller 113 combines the availabilities and the formats so that the display unit 13 can display the availability and the format of all of input signals 102, 106. Based on the information, the user can select an available input signal to watch more easily.

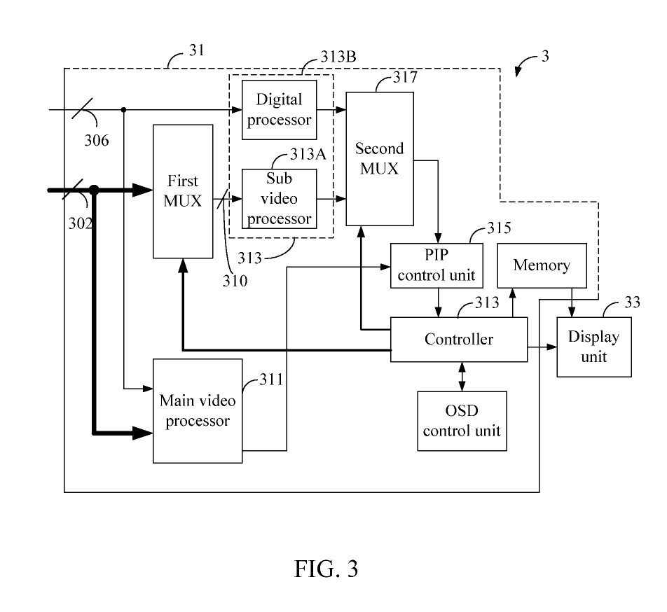

A second embodiment of the present invention is a multimedia processing apparatus 31, which is capable of being applied in a TV system 3 as shown in FIG. 3. In contrast to the first embodiment, the multimedia processing apparatus 31 of the TV system 3 further comprises a main video decoder 311 and a PIP control unit 315. Moreover, the analog sync processor 115A of the detector 115 in the first embodiment is replaced by a sub video decoder 313A of the detector 313, and the sub video decoder 313A is served not only as an analog sync processor, but also a video decoder. The descriptions of operations and functions of other elements which are the same as the first embodiment are redundant and not repeated herein.

Furthermore, the decoding of the sub video decoder 313A and the digital processor 313B allows the retrieval of display frames that are carried by the analog input signals 302 and the digital input signal 306. After decoding by the detector 313, the statuses of the input signals 302, 306 as well as the display frames are determined.

The main video decoder 311 decodes a main input signal, which is the input signal that the user is watching, for displaying main display frame on a full screen of the display unit 33. The sub video decoder 313A decodes the selected analog input signal 310 to obtain color difference information thereof in order to realize the format of the selected analog input signal 310, and also determine the availability of the selected analog input signal 310 as well as the analog sync processor 315A. Moreover, the sub video decoder 313A further decodes the input signals 302, 306. The available input signals decoded by the sub video decoder 313A would be transmitted to the PIP control unit 315 via the controller 313 for being processed as sub display frame, and the sub display frames of the available input signals would be displayed in inset windows on the display unit 33. On the other hand, the unavailable input signals would also decoded by the sub video decoder 313A and processed by the PIP control unit 315. Due to the unavailable status, the corresponding inset windows of the unavailable input signals would be, however, blank pictures. In conclusion, the main display frame of the input signal that the user is watching and the sub display frame of all input signals are presented in the PIP format, i.e. the former is embedded in the latter, on the display unit 33.

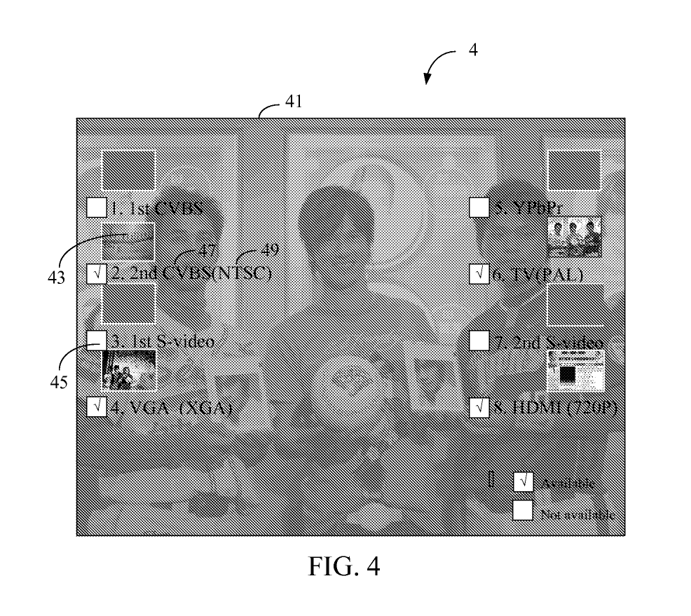

In this embodiment, the display unit 33 of the TV system 3 would illustrate the display frames of the detected input signal according to the manual input, and then the user may select manually from the detected input signals with a remote controller. When the user requires information of the input signals 302, 306, the user may enter a user interface menu 4 as shown in FIG. 4 with the remote controller during watching the main display frame 41 of a program on the TV system 3 corresponding to some input signals. The display unit 33 would broadcast the main display frame 41 and display the sub display frames 43, the availabilities 45, the formats 47, and the sources 49 of the available input signals simultaneously. According to information, which comprises the sub display frames 43, the availabilities 45, the formats 47, and sources 49 of all input signals in this embodiment, the user may select a preferred input signal, related to interesting program content of a specific display frame, from the plurality of input signals, and switch to a corresponding channel. Thus, the TV system 3 would broadcast the available TV sources and broadcast all manually.

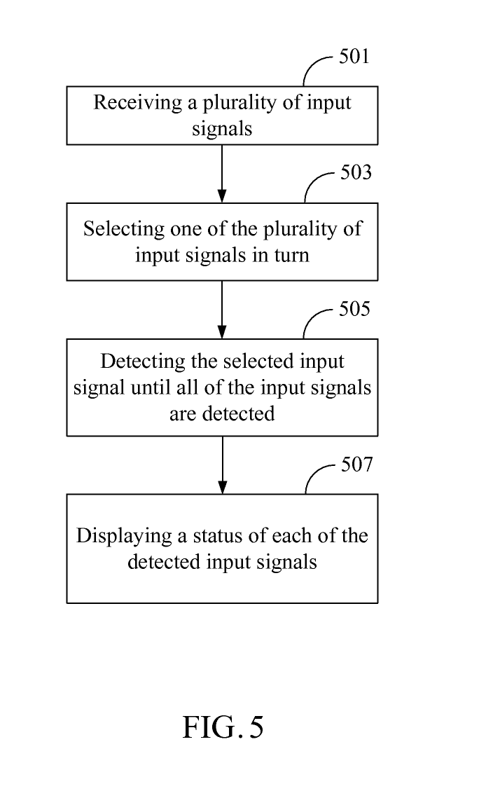

FIG. 5 shows a flow chart of a multimedia processing method adapted for a multimedia system, as noted in the first and second embodiments. In step 501, a plurality of input signals is received. Step 503 is executed to select one of the plurality of input signals in turn. Then, step 505 detects the selected input signal until all of the input signals have been detected. In step 507, a status of each detected input signal is displayed.

In addition to the steps shown in FIG. 5, the second embodiment is able to execute all of the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

With the present invention, the status of each input signal can be detected before a user chooses one to watch. These detected statuses are then shown so that the user knows which input signal is available without switching to each input signal. Moreover, the user may further get the sub display frames except for the statuses of input signals when watching another full screen display frame. By means of the aforementioned mechanism, the present invention has the advantages of higher response when user changes input signals, either a predetermined display priority setting or a user favorite setting, more robust for input signal detection, automatic input signal statuses detection, and input signals selection without interrupting the displaying program content.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A multimedia processing apparatus, comprising:
a multiplexer for receiving a plurality of input signals;
a controller for controlling the multiplexer to select one of the plurality of input signals in turn; and
a detector for detecting the selected input signal to generate a status of the selected input signal until all of the input signals are detected.

2. The multimedia processing apparatus as claimed in claim 1, wherein the status is one of a format and an availability of the selected input signal.

3. The multimedia processing apparatus as claimed in claim 1, further comprising a display unit for displaying the status of each of the detected input signals.

4. The multimedia processing apparatus as claimed in claim 3, wherein the detected input signals are displayed according to a plurality of predetermined priorities.

5. The multimedia processing apparatus as claimed in claim 3, wherein the detected input signals are displayed according to a manual input.

6. The multimedia processing apparatus as claimed in claim 1, wherein the detector is a format detector.

7. The multimedia processing apparatus as claimed in claim 6, wherein the detector decodes the selected input signal for the detection.

8. The multimedia processing apparatus as claimed in claim 1, further comprising a decoder for decoding the detected input signals.

9. The multimedia processing apparatus as claimed in claim 8, further comprising a display unit for displaying the detected input signals.

10. The multimedia processing apparatus as claimed in claim 1, wherein the multiplexer, the controller, and the detector operate periodically.

11. The multimedia processing apparatus as claimed in claim 1, wherein the detector is a decoder.

12. A multimedia processing method, comprising:
receiving a plurality of input signals;
selecting one of the plurality of input signals in turn; and
detecting the selected input signal to generate a status of the selected input signal until all of the input signals are detected.

13. The multimedia processing method as claimed in claim 12, wherein the status is one of a format and an availability of the selected input signal.

14. The multimedia processing method as claimed in claim 12, further comprising a step of displaying the status of each of the detected input signals.

15. The multimedia processing method as claimed in claim 14, wherein the detected input signals are displayed according to a plurality of predetermined priorities.

16. The multimedia processing method as claimed in claim 14, wherein the detected input signals are displayed according to a manual input.

17. The multimedia processing method as claimed in claim 12, wherein the detecting step is executed by a format detector.

18. The multimedia processing method as claimed in claim 17, wherein the detecting step comprises a step of decoding the selected input signal.

19. The multimedia processing method as claimed in claim 12, further comprising a step of decoding the detected input signal.

20. The multimedia processing method as claimed in claim 19, further comprising a step of displaying the detected input signal.

21. The multimedia processing method as claimed in claim 12, wherein the receiving step, the selecting step, and the detecting step are executed periodically.

22. The multimedia processing method as claimed in claim 12, wherein the step of detecting the at least one of the plurality of transmitted input signals is executed by a decoder.

23. A TV system, comprising:
a multiplexer for receiving a plurality of input signals;
a controller for controlling the multiplexer to select one of the plurality of input signals in turn;
a detector for detecting the selected input signal to generate a status of the selected input signal until all of the input signals are detected; and
a display unit for displaying the detected input signals.

24. A multimedia processing apparatus, comprising:
means for receiving a plurality of input signals;
means for selecting one of the plurality of input signals in turn; and
means for detecting the selected input signal to generate a status of the selected input signal until all of the input signals are detected.
